(19) United States
(12) Patent Application Publication
(10) Pub. No.: US 2015/0284284 A1
(43) Pub. Date: Oct. 8, 2015

(54) CLEAVING METHOD FOR TEMPERED GLASS

(71) Applicant: Nippon Electric Glass Co., Ltd., Shiga (JP)

(72) Inventors: Tomomi Konishi, Shiga (JP); Hiroyuki Nakatsu, Shiga (JP); Koji Ichikawa, Shiga (JP); Kazunobu Kunitomo, Shiga (JP); Hisahiro Takeuchi, Shiga (JP); Akira Awazu, Shiga (JP)

(21) Appl. No.: 14/420,161

(22) PCT Filed: Aug. 7, 2013
(86) PCT No.: PCT/JP2013/071399

§ 371 Date: Feb. 6, 2015

(30) Foreign Application Priority Data
Aug. 9, 2012 (JP) 2012-177155

(51) Int. Cl. C03B 33/02; C03B 33/03

(52) U.S. Cl. CPC C03B 33/0222; C03B 33/03

(57) ABSTRACT

A cleaving method for tempered glass includes forming a scribe line in the tempered glass from a front surface side of the tempered glass in a thickness direction along a preset cleaving line, followed by cleaving the tempered glass with the scribe line being set as a boundary. The tempered glass includes a front surface-side compressive stress layer formed on the front surface side and having compressive stress applied thereto, a back surface-side compressive stress layer formed on a back surface side of the tempered glass in the thickness direction and having compressive stress applied thereto, and an intermediate tensile stress layer formed between the front and back surface-side compressive stress layers and having tensile stress applied thereto. The forming of the scribe line includes increasing a thickness of the front surface-side compressive stress layer at least in the vicinity of the preset cleaving line.

### TECHNICAL FIELD

The present invention relates to a cleaving method for tempered glass, which involves forming a scribe line in the tempered glass so as to cleave the tempered glass.

### BACKGROUND ART

As is well known, tempered glass is obtained by tempering its surface layer regions through chemical tempering, such as ion exchange, or physical tempering, such as air cooling tempering, so that compressive stress layers having compressive stress applied thereto are formed on a front surface side and a back surface side of the tempered glass in its thickness direction. Thus, as compared to normal glass, the fracture strength of the tempered glass against tensile stress to be applied to each of the surface layer regions is enhanced significantly. Such tempered glass has been employed as, for example, cover glass of displays of smartphones, tablet PCs, and the like that have increasingly been widespread in recent years.

Incidentally, tempered glass is significantly difficult to cleave unlike normal glass due to the compressive stress layers formed in the surface layer regions of the tempered glass. Specifically, when cleaving normal glass, there has widely been employed a method involving forming a scribe line by pressing a front surface of the glass with a wheel cutter or the like, and then applying tensile stress onto the periphery of the scribe line, to thereby cleave the glass with the scribe line being set as a boundary. When this method is employed for cleaving the tempered glass, however, the scribe line for initiating the cleaving needs to be formed by cutting into the compressive stress layer, and hence a significant pressing force is undesirably necessary to form the scribe line.

Therefore, when manufacturing tempered glass in the related art, there has generally been employed a method involving cutting normal glass into individual sizes of products in advance, and then tempering the individual glass pieces at a final phase of the manufacturing process. However, this method is significantly inefficient particularly from the viewpoint of manufacturing efficiency, thereby raising a demand to develop a technology for satisfactorily cleaving the tempered glass, and by extension, satisfactorily forming the scribe line in the tempered glass.

To meet the demand, in Patent Literature 1, there is disclosed a method for forming the scribe line by cutting into the compressive stress layer of the tempered glass. Specifically, there is disclosed a method involving forming the scribe line with use of a wheel cutter having projections on its outer peripheral portion so as to fluctuate a pressure to be applied to the tempered glass when pressing the tempered glass. Thus, even with a small pressing force, the scribe line can be formed by cutting into the compressive stress layer.

### CITATION LIST

Patent Literature 1: JP 2008-7384 A

### SUMMARY OF INVENTION

### Technical Problems

However, even when the method disclosed in Patent Literature 1 is employed, several problems still remain unsolved.

That is, a tensile stress layer having tensile stress applied thereto as a reaction to the compressive stress is formed between the compressive stress layers formed on the front surface side and the back surface side of the tempered glass in its thickness direction. In addition to the tensile stress layer, the scribe line formed in the tempered glass includes a median crack extending in the thickness direction when the scribe line is formed. In view of those factors, as illustrated in FIG. 10, when a scribe line S is formed by cutting into a compressive stress layer A of tempered glass G by the method disclosed in Patent Literature 1, a distal end of the median crack is positioned inside a tensile stress layer B.

In this case, when the scribe line S (median crack) is formed in the tempered glass G beyond an appropriate depth, as illustrated in FIG. 11, the tensile stress applied to the tensile stress layer B causes a crack C generated from the median crack to self-propagate across the tempered glass G from a front surface Ga side to a back surface Gb side in the thickness direction. Further, as illustrated in FIG. 12, the tensile stress causes the crack C to self-propagate along a surface direction of the tempered glass G. At the instant when the scribe line S is formed in the tempered glass G, a load for forming the scribe is also applied, resulting in the most unstable state. Thus, there is a problem in that the crack C cannot be controlled.

For that reason, the scribe line S needs to be formed accurately at its appropriate depth, but the appropriate depth differs depending on the magnitude of the tensile stress applied to the tensile stress layer B, that is, the degree of tempering carried out for the tempered glass G. Therefore, when the type of tempered glass to be cleaved is changed, depending on that difference, the tool or the like to be used for forming the scribe line S needs to be adjusted again or changed undesirably.

As described above, according to the method disclosed in Patent Literature 1, the tempered glass can actually be cleaved, but the tolerance of the depth of the scribe line (median crack) to be formed in the tempered glass is narrow, and hence, depending on the degree of tempering carried out for the tempered glass to be cleaved, the depth of the scribe line to be formed in the tempered glass is required to be changed every time, to thereby form the scribe line accurately. As a result, this operation inevitably requires inappropriate time and effort, and is therefore not excellent from the viewpoint of manufacturing efficiency in actuality.

The present invention has been made in view of the above-mentioned circumstances, and it is therefore a technical object of the present invention to enable uniform and easy cleaving for various types of tempered glass obtained through different degrees of tempering, thereby enhancing manufacturing efficiency of the tempered glass.

### Solution to Problems

According to one embodiment of the present invention, which is devised to achieve the above-mentioned object, there is provided a cleaving method for tempered glass, comprising forming a scribe line on a front surface side of the tempered glass along a preset cleaving line, followed by cleaving the tempered glass with the scribe line as a boundary, the tempered glass comprising: a front surface-side compressive stress layer being formed on the front surface side of the tempered glass in the thickness direction and having compressive stress applied thereto; aback surface-side compressive stress layer being formed on a back surface side of the tempered glass in the thickness direction and having compressive stress applied thereto; and an intermediate tensile stress layer being formed between the front surface-side compressive stress layer and the back surface-side compressive stress layer and having tensile stress applied thereto, the forming of the scribe line comprising increasing a thickness of the front surface-side compressive stress layer at least in the vicinity of the preset cleaving line.

According to this method, when the scribe line is formed at a depth that exceeds the thickness of the front surface-side compressive stress layer before the thickness is increased but does not exceed the increased thickness of the front surface-side compressive stress layer irrespective of the appropriate depth of the scribe line that differs depending on the degree of tempering carried out for the tempered glass, the following advantages are obtained. That is, in this case, a median crack included in the scribe line is formed inside the front surface-side compressive stress layer increased in thickness. Therefore, such a risk is avoided that, during the forming of the scribe line, tensile stress is applied to a crack generated from the median crack, thereby being capable of preventing self-propagation of the crack in the thickness direction of the tempered glass or self-propagation of the crack along a surface direction of the tempered glass. Further, every time various types of tempered glass obtained through different degrees of tempering are to be cleaved, the depth of the scribe line to be formed in each tempered glass does not need to be changed. When the increasing of the thickness of the front surface-side compressive stress layer is canceled after the scribe line is formed, the scribe line may be brought into a state of cutting into the front surface-side compressive stress layer before the thickness is increased. However, the scribe line is already formed in the tempered glass, and hence no scribing load is applied, resulting in a relatively stable state. Thus, the self-propagation of the crack in the thickness direction or the surface direction can be prevented, thereby being capable of cleaving the tempered glass along the scribe line. As described above, according to the method of the present invention, along with the increasing of the thickness of the front surface-side compressive stress layer, the tolerance of the depth of the scribe line (median crack) to be formed in the tempered glass is increased. Therefore, various types of tempered glass obtained through different degrees of tempering can be cleaved uniformly and easily, thereby being capable of enhancing the manufacturing efficiency of the tempered glass.

In the above-mentioned method, the increasing of the thickness of the front surface-side compressive stress layer may be carried out by curving the front surface of the tempered glass into a concave surface at least in the vicinity of the preset cleaving line.

With this method, at least in the vicinity of the preset cleaving line, at the front surface side with respect to a center portion of the tempered glass in the thickness direction (hereinafter referred to as “center in the thickness direction”), compressive stress caused by the curving is newly applied in addition to the compressive stress and the tensile stress applied to the tempered glass before the front surface is curved. As a result, in a region of the intermediate tensile stress layer at the front surface side with respect to the center in the thickness direction, apart of the tensile stress is canceled due to the newly applied compressive stress, and hence the thickness of the intermediate tensile stress layer can be reduced. Along with this, the thickness of the front surface-side compressive stress layer can be increased by an amount corresponding to the reduction in thickness of the intermediate tensile stress layer. Further, in this case, even when the scribe line is formed beyond the increased thickness of the front surface-side compressive stress layer, at the front surface side with respect to the center in the thickness direction, the tensile stress applied to the intermediate tensile stress layer before the curving is mitigated due to the newly applied compressive stress. Therefore, such a risk can be minimized that the crack generated from the median crack self-propagates due to the tensile stress. Note that, in this case, at the back surface side with respect to the center in the thickness direction, tensile stress is newly applied to the tempered glass through the curving.

In the above-mentioned method, the increasing of the thickness of the front surface-side compressive stress layer may be carried out by heating the front surface side of the tempered glass and/or cooling the back surface side of the tempered glass in the vicinity of the preset cleaving line.

With this method, when the front surface side of the tempered glass is heated, in the vicinity of the preset cleaving line, the heated region is thermally expanded so as to push out the region on the periphery of the heated region. As a reaction force thereto, the heated region is compressed by the peripheral region so that the compressive stress is applied. When the back surface side of the tempered glass is cooled, on the other hand, in the vicinity of the preset cleaving line, the cooled region is thermally contracted so as to pull in the region on the periphery of the cooled region. As a reaction force thereto, the cooled region is tensioned by the peripheral region so that the tensile stress is applied. Further, when both the heating of the front surface side and the cooling of the back surface side are carried out, both the above-mentioned compressive stress and tensile stress can be applied. Therefore, in those cases, similar effects to the above-mentioned effects can be obtained.

In the above-mentioned method, it is preferred that a depth of the scribe line in the thickness direction be less than or equal to the increased thickness of the front surface-side compressive stress layer.

With this setting, such a risk can reliably be avoided that, during the forming of the scribe line, tensile stress is applied to the crack generated from the median crack. Therefore, it is possible to substantially completely eliminate the risk of self-propagation of the crack in the thickness direction of the tempered glass or self-propagation of the crack along the surface direction of the tempered glass.

In the above-mentioned method, it is preferred that the thickness of the front surface-side compressive stress layer before the thickness is increased be 30% or less of a thickness of the tempered glass.

That is, as the thickness of the front surface-side compressive stress layer before the thickness is increased is smaller, the tensile stress applied to the intermediate tensile stress layer before the thickness is reduced is also smaller. Therefore, the tensile stress is easily canceled or reduced due to the newly applied compressive stress. In a case of carrying out tempering to such a degree that the thickness of the front surface-side compressive stress layer before the thickness is increased is 30% or less of the thickness of the tempered glass, the above-mentioned effects can be obtained more satisfactorily.

The above-mentioned method may further comprise, after the forming of the scribe line, applying tensile stress around the scribe line so as to cleave the tempered glass. In addition, the above-mentioned method may further comprise, after the forming of the scribe line, canceling the increasing of the thickness of the front surface-side compressive stress layer, and maintaining a state in which the increasing of the thickness of the front surface-side compressive stress layer is canceled.

Note that, in the case of canceling the increasing of the thickness of the front surface-side compressive stress layer and maintaining this state after the forming of the scribe line, the tempered glass is cleaved in the following manner. That is, through the cancellation of the increasing of the thickness of the front surface-side compressive stress layer, the thickness of the intermediate tensile stress layer is recovered to a state before the thickness of the front surface-side compressive stress layer is increased. In this case, the scribe line is formed in a state of cutting into the front surface-side compressive stress layer by only an amount corresponding to the thickness before the increase. Therefore, the distal end of the median crack included in the scribe line is positioned inside the intermediate tensile stress layer. As a result, when this state is maintained, the crack generated from the median crack propagates from the front surface side to the back surface side with the elapse of time due to the tensile stress applied to the intermediate tensile stress layer, thereby being capable of cleaving the tempered glass. Further, the tempered glass maintained in this state can easily be cleaved when the tensile stress is further applied onto the periphery of the scribe line. Accordingly, the tempered glass can be cleaved at a desired timing.

In the above-mentioned method, the forming of the scribe line may be carried out by pressing a wheel cutter or by irradiation of laser.

### Advantageous Effects of Invention

As described above, according to the one embodiment of the present invention, along with the increasing of the thickness of the front surface-side compressive stress layer, the tolerance of the depth of the scribe line (median crack) to be formed in the tempered glass is increased. Therefore, various types of tempered glass obtained through different degrees of tempering can be cleaved uniformly and easily, thereby being capable of enhancing the manufacturing efficiency of the tempered glass.

### BRIEF DESCRIPTION OF DRAWINGS

FIG. 1 is a front sectional view illustrating a scribing apparatus to be used in a cleaving method for tempered glass according to a first embodiment of the present invention.

FIG. 2a is a side view illustrating stress applied to tempered glass in advance.

FIG. 2b is a side view illustrating stress applied by curving the tempered glass.

FIG. 3 is a side view illustrating actions of the cleaving method for tempered glass according to the first embodiment of the present invention.

FIG. 4 is a side view illustrating the actions of the cleaving method for tempered glass according to the first embodiment of the present invention.

FIG. 5 is a front sectional view illustrating a scribing apparatus to be used in a cleaving method for tempered glass according to a second embodiment of the present invention.

FIG. 6 is a front sectional view illustrating a scribing apparatus to be used in a cleaving method for tempered glass according to a third embodiment of the present invention.

FIG. 7 is a front sectional view illustrating a scribing apparatus to be used in a cleaving method for tempered glass according to a fourth embodiment of the present invention.

FIG. 8a is a front view illustrating a scribing apparatus to be used in a cleaving method for tempered glass according to an example of the present invention.

FIG. 8b is a plan view illustrating the scribing apparatus to be used in the cleaving method for tempered glass according to the example of the present invention.

FIG. 9a is a front view illustrating a scribing apparatus to be used in a cleaving method for tempered glass according to a comparative example.

FIG. 9b is a plan view illustrating the scribing apparatus to be used in the cleaving method for tempered glass according to the comparative example.

FIG. 10 is a side view illustrating a related-art cleaving method for tempered glass.

FIG. 11 is a side view illustrating self-propagation of a crack.

FIG. 12 is a plan view illustrating the self-propagation of the crack.

### DESCRIPTION OF EMBODIMENTS

Now, a cleaving method for tempered glass according to a first embodiment of the present invention is described with reference to the accompanying drawings. In the following description, a “front surface” of tempered glass herein refers to a surface on which a scribe line is to be formed, and a “back surface” of the tempered glass herein refers to a surface opposite to the front surface.

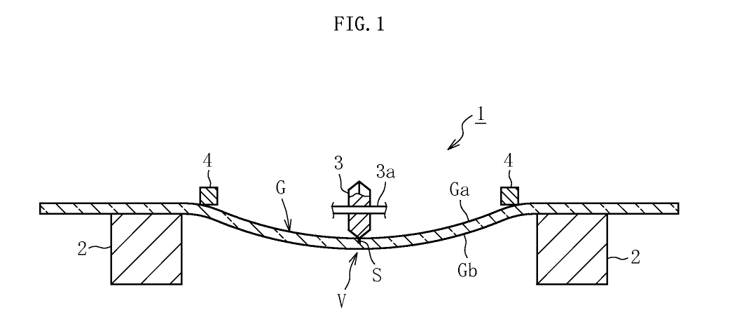

FIG. 1 is a front sectional view illustrating a scribing apparatus to be used in the cleaving method for tempered glass according to the first embodiment of the present invention. As illustrated in FIG. 1, a scribing apparatus 1 comprises, as main components thereof, support stages 2 for supporting tempered glass G, a wheel cutter 3 for forming a scribe line S in a front surface Ga of the tempered glass G, and pressure bars 4 for downwardly pressing and curving the tempered glass G placed on the support stages 2.

The support stages 2 are installed in pairs in parallel to both edge portions of the tempered glass G in its width direction (in FIG. 1, lateral direction), and are configured to support the entire region of the tempered glass G in its longitudinal direction (in FIG. 1, direction perpendicular to the drawing sheet) orthogonal to the width direction. A space V for allowing the curved tempered glass G to sag downwardly is formed between both the support stages 2.

The wheel cutter 3 is provided with its traveling direction set parallel to the longitudinal direction of the tempered glass G, and is configured to rotate about a shaft 3a passing through the wheel cutter 3. The wheel cutter 3 is substantially formed into a shape of a bead of an abacus, and an outer peripheral portion of the wheel cutter 3 configured to rotate about the shaft 3a is gradually increased in diameter as approaching from both end portions toward a center portion along an axial direction. Further, the wheel cutter 3 is subjected to a pressure from a cylinder (not shown). When the wheel cutter 3 rotates and the outer peripheral portion presses the front surface Ga of the tempered glass G, the scribe line S is formed.

The pressure bars 4 are provided in pairs in parallel to the longitudinal direction of the tempered glass G at an inner side of the support stages 2 in the width direction of the tempered glass G. Further, when the pair of pressure bars 4 presses the front surface Ga of the tempered glass G downwardly, the front surface Ga of the tempered glass G is curved into a concave surface at a position between both the support stages 2, and the curved tempered glass G sags into the space V.

Now, actions of the cleaving method for tempered glass using the scribing apparatus 1 are described.

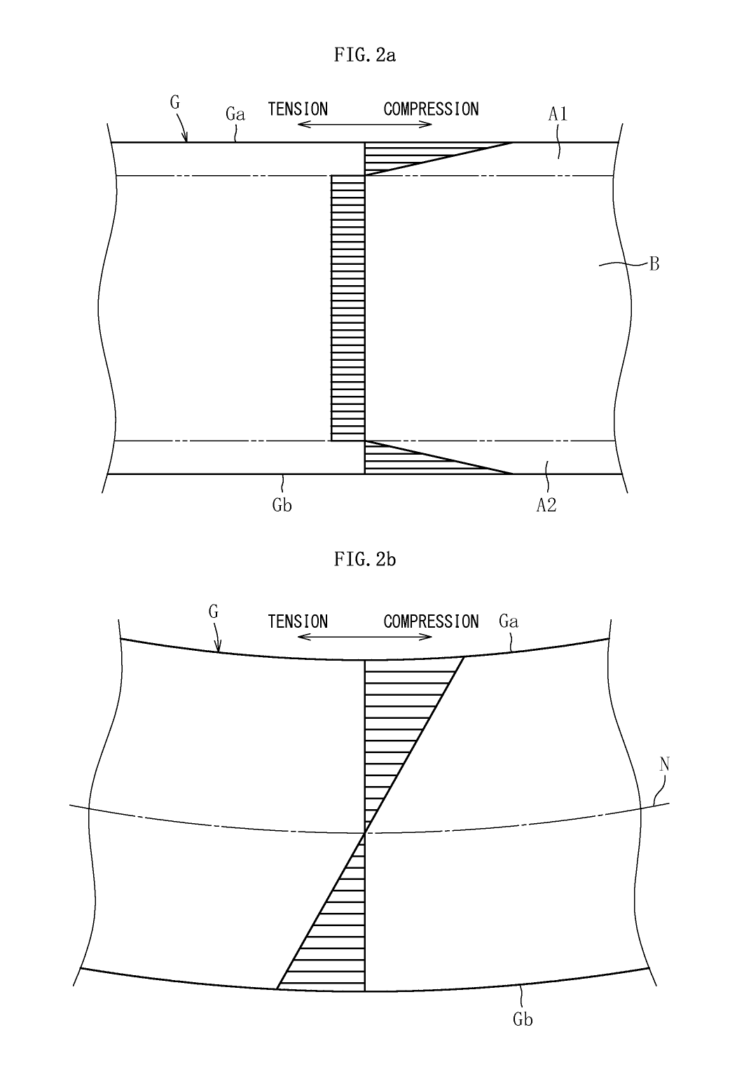

As illustrated in FIG. 2a, in the tempered glass G, a front surface-side compressive stress layer A1 being formed on the front surface Ga side of the tempered glass G and having compressive stress applied thereto, a back surface-side compressive stress layer A2 being formed on a back surface Gb side of the tempered glass G and having compressive stress applied thereto, and an intermediate tensile stress layer B being formed between the front surface-side compressive stress layer A1 and the back surface-side compressive stress layer A2 and having tensile stress applied thereto are formed in advance.

When the pressure bars 4 press the tempered glass G so as to curve the front surface Ga into a concave surface, as illustrated in FIG. 2b, compressive stress and tensile stress caused by the curving of the tempered glass G are newly applied to the tempered glass G in addition to the compressive stress and the tensile stress applied to the tempered glass G before the curving. Specifically, due to the curving, compressive stress is newly applied to the front surface Ga side with respect to a center N in a thickness direction, whereas tensile stress is newly applied to the back surface Gb side with respect to the center N in the thickness direction.

Thus, in a region of the intermediate tensile stress layer B at the front surface Ga side with respect to the center N in the thickness direction, a part of the tensile stress is canceled due to the newly applied compressive stress, and hence the thickness of the intermediate tensile stress layer B is reduced.

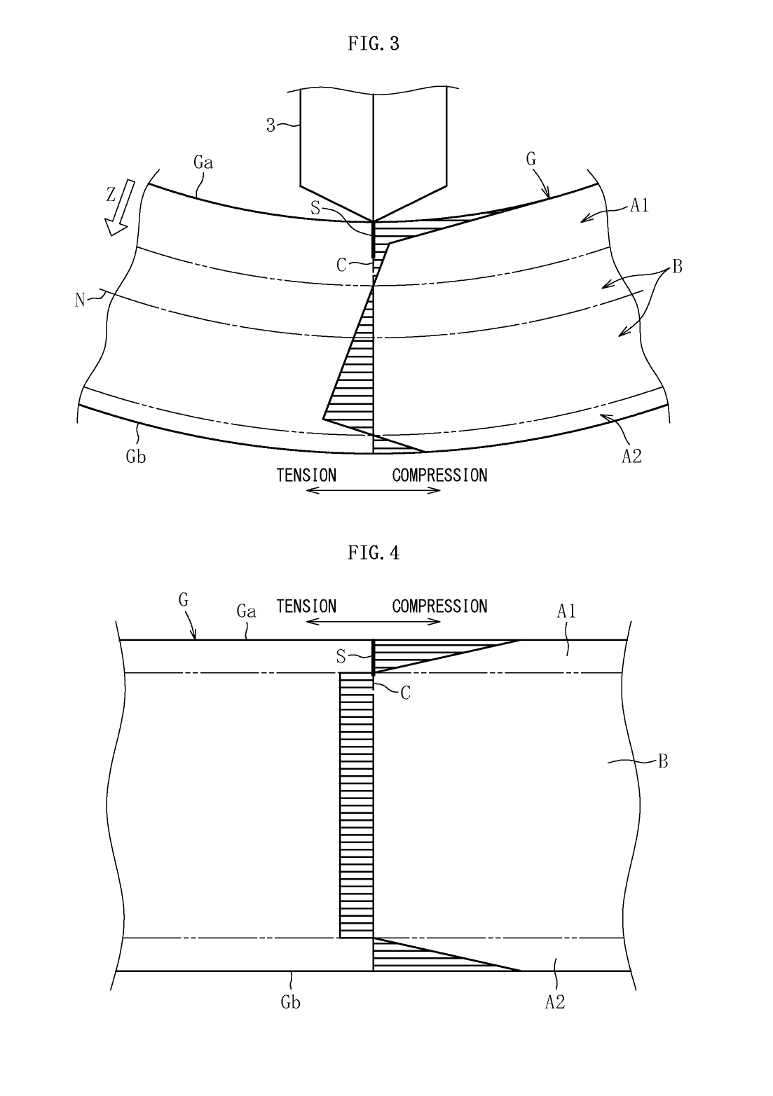

Along with this, as illustrated in FIG. 3, the thickness of the front surface-side compressive stress layer A1 is increased in a Z direction of FIG. 3 by an amount corresponding to the reduction in thickness of the intermediate tensile stress layer B.

After the curving of the tempered glass G, as illustrated in FIG. 3, the wheel cutter 3 is used to form the scribe line S at a depth that does not exceed the increased thickness of the front surface-side compressive stress layer A1. Accordingly, a median crack included in the scribe line S is formed inside the front surface-side compressive stress layer A1 increased in thickness. Therefore, such a risk is avoided that tensile stress is applied to a crack C generated from the median crack, thereby preventing self-propagation of the crack C in the thickness direction of the tempered glass G (direction from the front surface Ga side toward the back surface Gb side) or self-propagation of the crack C along a surface direction of the tempered glass G.

In this case, it is preferred that the scribe line S be formed at a depth that exceeds the thickness of the front surface-side compressive stress layer A1 before the thickness is increased but does not exceed the increased thickness of the front surface-side compressive stress layer A1 irrespective of an appropriate depth of the scribe line S that differs depending on the degree of tempering carried out for the tempered glass G. Therefore, the tolerance of the depth of the scribe line S (median crack) to be formed in the tempered glass G can be increased. As a result, every time various types of tempered glass G obtained through different degrees of tempering are to be cleaved, the depth of the scribe line S to be formed in each tempered glass G does not need to be changed. When the increasing of the thickness of the front surface-side compressive stress layer A1 is canceled after the scribe line S is formed, as illustrated in FIG. 4, the scribe line S is in a state of cutting into the front surface-side compressive stress layer A1 before the thickness is increased. As a result, when the front surface Ga of the tempered glass G is pressed with a snapping member or the like so as to apply tensile stress onto the periphery of the formed scribe line S, the tempered glass G can be cleaved along the scribe line S.

Further, the tempered glass G may be cleaved by forming the scribe line S, then canceling the increasing of the thickness of the front surface-side compressive stress layer A1, and maintaining this state. In this case, the tempered glass G is cleaved in such a manner that the crack C generated from the median crack propagates from the front surface Ga side to the back surface Gb side with the elapse of time due to the tensile stress applied to the intermediate tensile stress layer B after the cancellation of the increasing of the thickness of the front surface-side compressive stress layer A1. Note that, the tempered glass G maintained in this state can easily be cleaved when the tensile stress is further applied onto the periphery of the scribe line S. Accordingly, the tempered glass G may be cleaved at a desired timing.

As described above, along with the increasing of the thickness of the front surface-side compressive stress layer A1, the tolerance of the depth of the scribe line S (median crack) to be formed in the tempered glass G is increased. As a result, various types of tempered glass G obtained through different degrees of tempering can be cleaved along the scribe line S uniformly and easily, thereby being capable of enhancing the manufacturing efficiency of the tempered glass G.

Even if the scribe line S is undesirably formed at a depth that exceeds the increased thickness of the front surface-side compressive stress layer A1, the compressive stress newly applied onto the front surface Ga side with respect to the center N in the thickness direction mitigates the tensile stress applied to the intermediate tensile stress layer B before the curving of the tempered glass G. Therefore, such a risk can be minimized that the crack C generated from the median crack self-propagates in the thickness direction or the surface direction of the tempered glass G due to the tensile stress.

Now, a cleaving method for tempered glass according to a second embodiment of the present invention is described with reference to the accompanying drawings. Note that, in the drawings illustrating the cleaving method for tempered glass according to the second embodiment, components having the same functions or shapes as those of the scribing apparatus according to the above-mentioned first embodiment are represented by same reference symbols, and redundant description is therefore omitted herein.

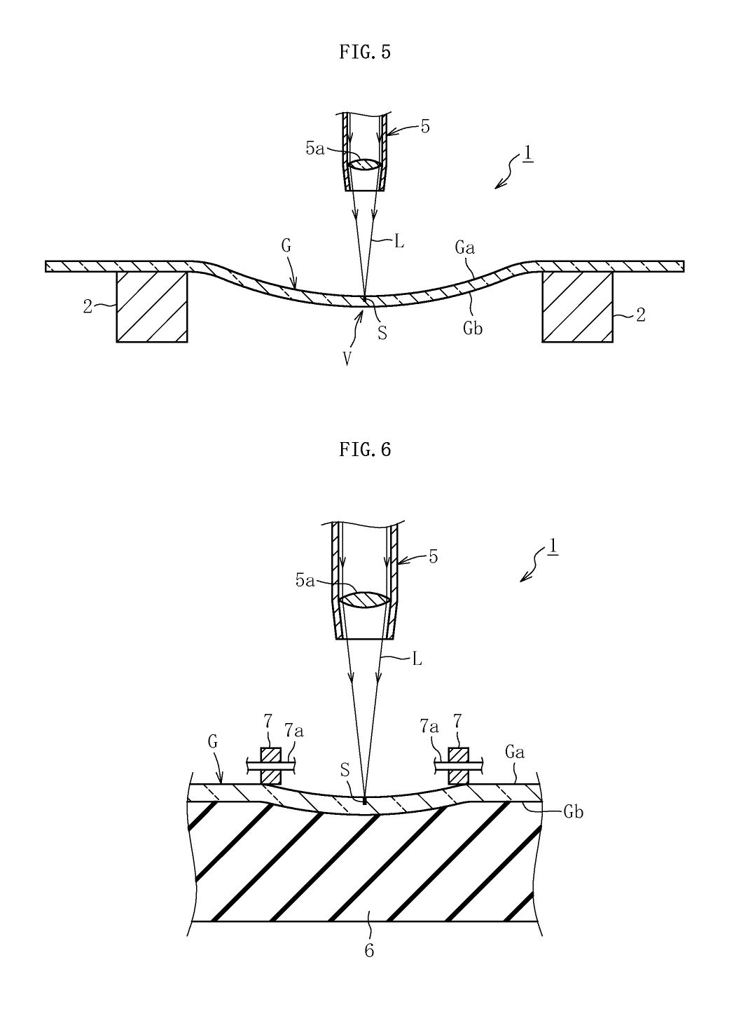

FIG. 5 is a front sectional view illustrating a scribing apparatus to be used in the cleaving method for tempered glass according to the second embodiment of the present invention. A scribing apparatus 1 of the second embodiment differs from the scribing apparatus 1 to be used in the cleaving method for tempered glass according to the above-mentioned first embodiment in that a laser irradiation device 5 is provided in place of the wheel cutter 3, and that the pressure bars 4 are omitted.

The laser irradiation device 5 is installed so as to be movable along the longitudinal direction of the tempered glass G placed on the support stages 2, and is formed into a substantially cylindrical shape. Further, a condenser lens 5a is provided inside the laser irradiation device 5. The condenser lens 5a is configured to condense laser L emitted from a laser oscillation device (not shown) so as to irradiate the tempered glass G while focusing on the tempered glass G. With the above-mentioned structure, the laser irradiation device 5 irradiates the tempered glass G with the laser L while moving along the tempered glass G, to thereby continuously form the scribe line S in the front surface Ga of the tempered glass G.

Now, actions of the cleaving method for tempered glass using the scribing apparatus 1 are described.

The tempered glass G placed on the support stages 2 is deflected downwardly due to the self-weight of the tempered glass G. Thus, the front surface Ga of the deflected tempered glass G is curved into a concave surface. Therefore, compressive stress and tensile stress caused by the curving of the tempered glass G are newly applied to the tempered glass G in addition to the compressive stress and the tensile stress applied to the tempered glass G before the curving. As a result, it is possible to obtain similar effects to the above-mentioned effects obtained through the actions of the cleaving method for tempered glass according to the above-mentioned first embodiment.

Now, a cleaving method for tempered glass according to a third embodiment of the present invention is described with reference to the accompanying drawings. Note that, in the drawings illustrating the cleaving method for tempered glass according to the third embodiment, components having the same functions or shapes as those of the scribing apparatus according to the above-mentioned second embodiment are represented by same reference symbols, and redundant description is therefore omitted herein.

FIG. 6 is a front sectional view illustrating a scribing apparatus to be used in the cleaving method for tempered glass according to the third embodiment of the present invention. A scribing apparatus 1 of the third embodiment differs from the scribing apparatus 1 to be used in the cleaving method for tempered glass according to the above-mentioned second embodiment in that a support member 6 is provided in place of the support stages 2, and that pressure rollers 7 for downwardly pressing and curving the tempered glass G placed on the support member 6 are provided.

The support member 6 is configured to support the entire back surface Gb of the tempered glass G. Further, the entire support member 6 is made of rubber so that the front surface of the support member 6 is elastically deformed along with the curving of the tempered glass G.

The pressure rollers 7 are provided in pairs with their traveling direction set parallel to the longitudinal direction of the tempered glass G, and are each configured to rotate about a shaft 7a passing through the pressure roller 7. In addition, both the pressure rollers 7 are configured to move in the longitudinal direction of the tempered glass G in synchronization with the laser irradiation device 5, and are each subjected to a pressure from a cylinder (not shown). Thus, outer peripheral portions of the pressure rollers 7 sequentially press the front surface Ga of the tempered glass G along the longitudinal direction so as to sequentially curve a part of the front surface Ga of the tempered glass G positioned between both the pressure rollers 7.

Now, actions of the cleaving method for tempered glass using the scribing apparatus 1 are described.

The part of the front surface Ga of the tempered glass G positioned between both the pressure rollers 7 is sequentially pressed along the longitudinal direction so as to be curved into a concave surface. Therefore, compressive stress and tensile stress caused by the curving of the tempered glass G are newly applied to the tempered glass G in addition to the compressive stress and the tensile stress applied to the tempered glass G before the curving. As a result, it is possible to obtain similar effects to the above-mentioned effects obtained through the actions of the cleaving method for tempered glass according to the above-mentioned first embodiment.

Now, a cleaving method for tempered glass according to a fourth embodiment of the present invention is described with reference to the accompanying drawings. Note that, in the drawings illustrating the cleaving method for tempered glass according to the fourth embodiment, components having the same functions or shapes as those of the scribing apparatus according to the above-mentioned first embodiment are represented by same reference symbols, and redundant description is therefore omitted herein.

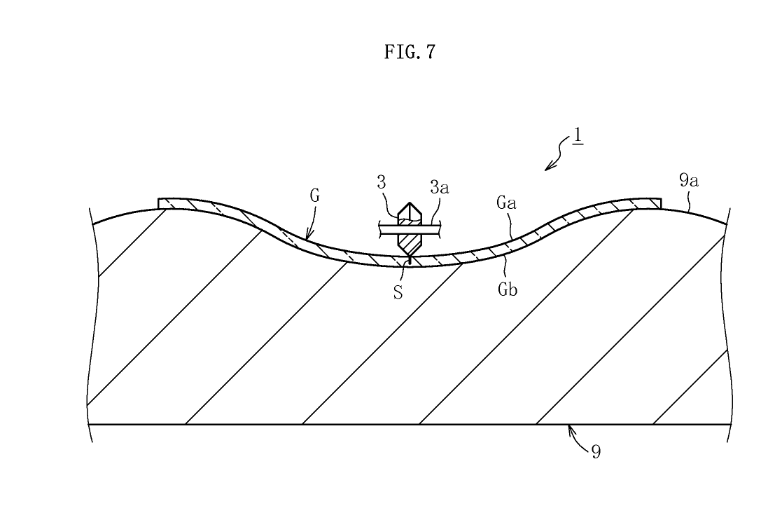

FIG. 7 is a front sectional view illustrating a scribing apparatus to be used in the cleaving method for tempered glass according to the fourth embodiment of the present invention. A scribing apparatus 1 of the fourth embodiment differs from the scribing apparatus 1 to be used in the cleaving method for tempered glass according to the above-mentioned first embodiment in that a support plate 9 is provided in place of the support stages 2, and that the pressure bars 4 are omitted.

The support plate 9 is configured to support the entire back surface Gb of the tempered glass G. A placement surface 9a on which the tempered glass G is placed has convex portions raised upwardly at both ends of the placement surface 9a in the width direction and a concave portion depressed downwardly at a center of the placement surface 9a in the width direction. Thus, the tempered glass G placed on the support plate 9 is deformed in conformity with the shape of the placement surface 9a.

Now, actions of the cleaving method for tempered glass using the scribing apparatus 1 are described.

The tempered glass G placed on the support plate 9 is deformed and curved so that the front surface Ga of the tempered glass G becomes a concave surface. Therefore, compressive stress and tensile stress caused by the curving of the tempered glass G are newly applied to the tempered glass G in addition to the compressive stress and the tensile stress applied to the tempered glass G before the curving. As a result, it is possible to obtain similar effects to the above-mentioned effects obtained through the actions of the cleaving method for tempered glass according to the above-mentioned first embodiment.

Note that, in the cleaving method for tempered glass according to each of the above-mentioned first to fourth embodiments, it is preferred that the thickness of the front surface-side compressive stress layer A1 before the thickness is increased be 30% or less of the thickness of the tempered glass G.

As the thickness of the front surface-side compressive stress layer A1 before the thickness is increased is smaller, the tensile stress applied to the intermediate tensile stress layer B before the thickness is reduced is also smaller. Therefore, the tensile stress is easily canceled or reduced due to the newly applied compressive stress. In a case of carrying out tempering to such a degree that the thickness of the front surface-side compressive stress layer A1 before the thickness is increased is 30% or less of the thickness of the tempered glass G, the above-mentioned effects can be obtained more satisfactorily.

In this case, the cleaving method for tempered glass according to the present invention is not limited to the method described in each of the above-mentioned embodiments. For example, in the above-mentioned embodiments, the front surface of the tempered glass is curved into a concave surface so as to increase the thickness of the front surface-side compressive stress layer. Alternatively, the thickness may be increased by heating the front surface of the tempered glass with a heater, hot air, a laser, or the like and cooling the back surface of the tempered glass with a fluid to be sprayed, a cooling device, or the like.

In this case, at the front surface side of the tempered glass, the heated region is thermally expanded so as to push out the region on the periphery of the heated region. As a reaction force thereto, the heated region is compressed by the peripheral region so that the compressive stress is applied. At the back surface side of the tempered glass, on the other hand, the cooled region is thermally contracted so as to pull in the region on the periphery of the cooled region. As a reaction force thereto, the cooled region is tensioned by the peripheral region so that the tensile stress is applied. Thus, it is possible to obtain similar effects to the effects obtained when the front surface of the tempered glass is curved into a concave surface. Note that, those effects may be obtained also when only one of the heating of the front surface and the cooling of the back surface is carried out.

Further, even the method of curving the front surface of the tempered glass into a concave surface is not limited to that of the above-mentioned embodiments. For example, the front surface of the tempered glass may be curved by the pressing force of the wheel cutter itself without using the pressure bars and the pressure rollers unlike the above-mentioned first and third embodiments. Alternatively, a plurality of suction holes may be formed in a surface plate whose placement surface on which the tempered glass is placed is formed into a concave surface, to thereby apply a negative pressure to the tempered glass through the suction holes. In this case, the tempered glass having the negative pressure applied thereto is sucked onto the placement surface so that the front surface of the tempered glass is curved into a concave surface in conformity with the shape of the placement surface.

In addition, the above-mentioned embodiments are directed to the case where the tempered glass is cleaved in only one direction, but the cleaving method for tempered glass according to the present invention is also applicable to, for example, a case where the tempered glass is cleaved in a cruciform pattern with a first preset cleaving line and a second preset cleaving line orthogonal to each other being set as boundaries. In this case, a plurality of pins or the like for downwardly pressing the tempered glass are provided along both the preset cleaving lines at positions in the vicinity of the preset cleaving lines. When the cleaving is carried out along the first preset cleaving line, the tempered glass is pressed with only the pins provided in the vicinity of the first preset cleaving line so that the front surface of the tempered glass becomes a concave surface. When the cleaving is carried out along the second preset cleaving line, on the other hand, the tempered glass is pressed with only the pins provided in the vicinity of the second preset cleaving line so that the front surface of the tempered glass becomes a concave surface.

### EXAMPLE

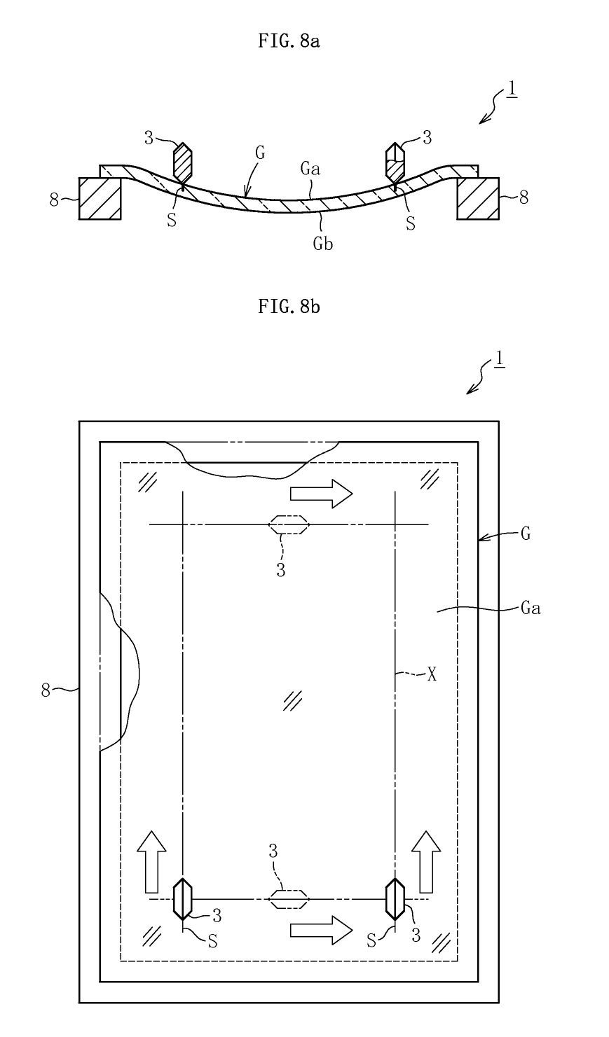

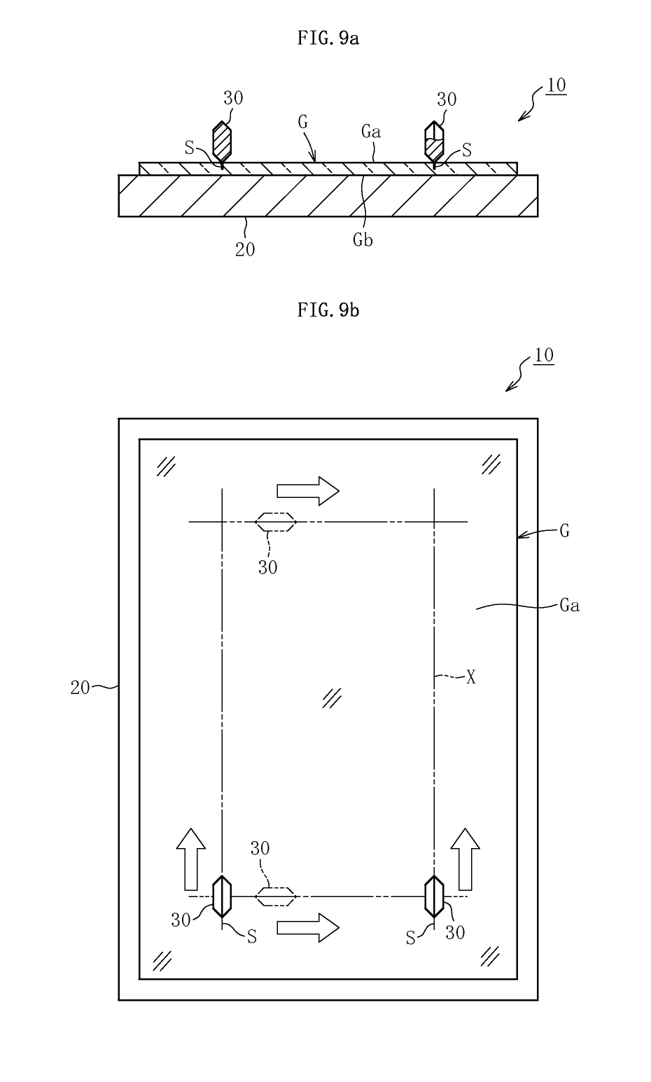

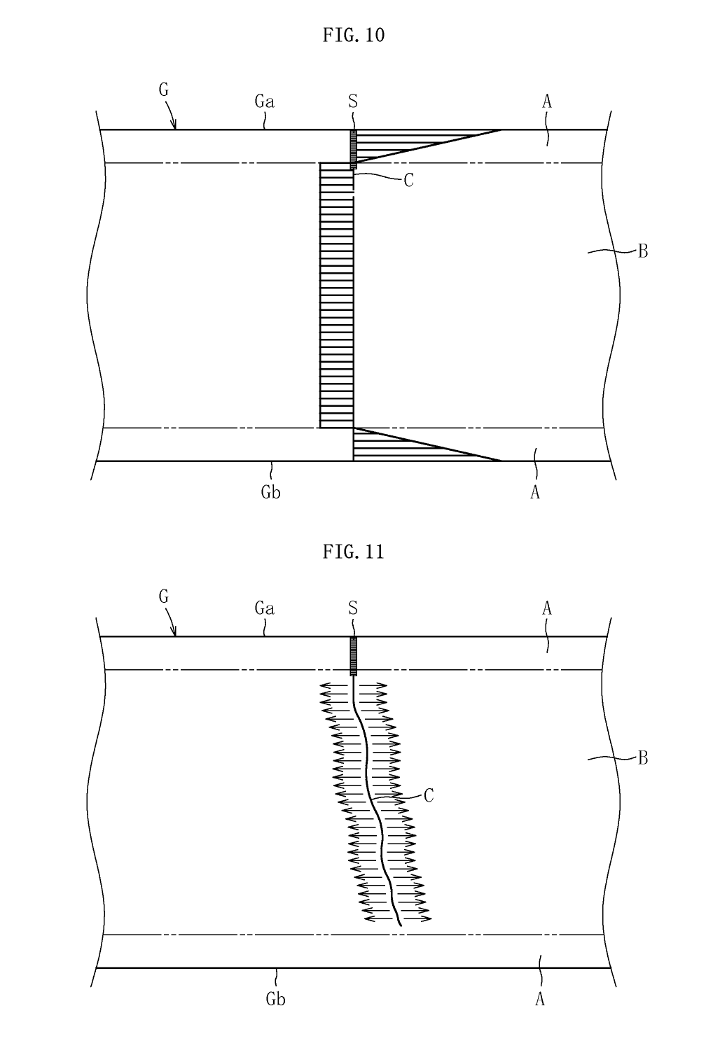

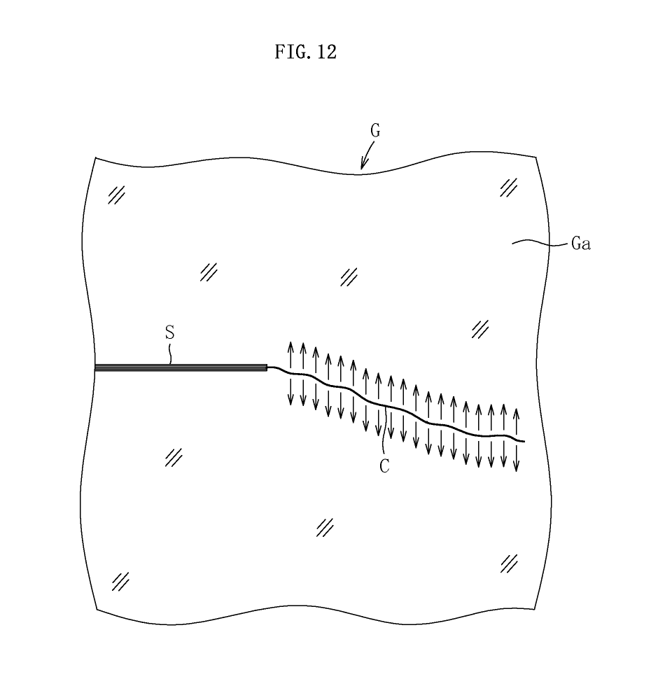

As an example of the present invention, a scribing apparatus illustrated in FIGS. 8a and 8b and a scribing apparatus illustrated in FIGS. 9a and 9b were used to form scribe lines in a front surface of rectangular tempered glass, and then the tempered glass was cleaved with the scribe lines being set as boundaries. Then, an examination was conducted to determine the frequency of self-propagation of cracks generated from median cracks during the forming of the scribe lines.

First, the structures of the scribing apparatus used in the example of the present invention and in a comparative example are described. As illustrated in FIGS. 8a and 8b, a scribing apparatus 1 used in a cleaving method for tempered glass according to the example of the present invention is constructed of a frame-like member 8 for supporting the tempered glass G, and the wheel cutter 3 for pressing the front surface Ga of the tempered glass G so as to curve the front surface Ga into a concave surface, and to form the scribe line S. The frame-like member 8 is configured to support the entire periphery of an edge portion of the tempered glass G, and the dimensions of the frame-like member 8 in its cross section are 0.7 mm wide and 0.7 mm high. The wheel cutter 3 has a similar structure to that of the wheel cutter provided in the scribing apparatus to be used in the cleaving method for tempered glass according to the above-mentioned first embodiment. The outer diameter of the wheel cutter 3 is 5.0 mm, and the angle of a distal end of an outer peripheral portion of the wheel cutter 3 is 110°. Further, the rate of forming of the scribe line S in the tempered glass G is set to 25 m/min.

As illustrated in FIGS. 9a and 9b, ascribing apparatus 10 used in a cleaving method for tempered glass according to the comparative example is constructed of a surface plate 20 on which the tempered glass G is placed, and a wheel cutter 30 for pressing the front surface Ga of the tempered glass G so as to form the scribe line S. The surface plate 20 is configured to support the entire back surface Gb of the tempered glass G. The wheel cutter 30 has completely the same structure as that of the wheel cutter 3 provided in the scribing apparatus 1 used in the cleaving method for tempered glass according to the above-mentioned example.

Next, the tempered glass G to be cleaved is described. In the rectangular tempered glass G, the length in the width direction, the length in the longitudinal direction, and the thickness are 730 mm, 920 mm, and 0.8 mm, respectively. Further, the thickness of each of the front surface-side compressive stress layer and the back surface-side compressive stress layer is 33 μm, and the magnitude of the applied compressive stress is 590 MPa. Further, the magnitude of the tensile stress applied to the intermediate tensile stress layer is 26.9 MPa.

Lastly, cleaving conditions of the tempered glass G are described. First, as indicated by the arrows of FIGS. 8b and 9b, the scribe lines S were formed along preset cleaving lines X in the longitudinal direction of the tempered glass G. Next, the scribe lines S were similarly formed along preset cleaving lines X in the width direction of the tempered glass G. Those scribe lines S were formed at positions spaced apart by 20 mm inwardly from the edge portion of the tempered glass G in both the longitudinal direction and the width direction. After that, the tempered glass G was cleaved with the formed scribe lines S being set as boundaries. The pressure to be applied during the forming of the scribe line S (pressure for pressing the tempered glass G) was changed to 0.04 MPa, 0.05 MPa, and 0.06 MPa, and the above-mentioned steps were carried out 10 times under each of those pressures. Then, an examination was conducted to determine the number of times of self-propagation of the cracks generated from the median cracks throughout the operations carried out 10 times.

As results of the above-mentioned examination, the following table shows the number of times of self-propagation of the cracks during the forming of the scribe lines under the respective pressures.

TABLE 1

| | Example | | | Comparative Example | | |
|---|---|---|---|---|---|---|
| | Pressure [MPa] | | | | | |
| | 0.04 | 0.05 | 0.06 | 0.04 | 0.05 | 0.06 |
| Number of times of self- | 0 | 0 | 0 | 10 | 7 | 10 |
| propagation [time] | | | | | | |

As is apparent from the above table, in the comparative example, the self-propagation of the cracks generated from the median cracks occurred frequently under any of the magnitudes of the pressure for pressing the tempered glass G, that is, 0.04 MPa, 0.05 MPa, and 0.06 MPa. Therefore, the tempered glass G was not able to be cleaved satisfactorily with the scribe lines S being set as boundaries. In contrast, in the example of the present invention, the self-propagation of the cracks did not occur even once irrespective of the magnitudes of the pressure, with the result that the tempered glass G was able to be cleaved satisfactorily. The reason is assumed as follows. In the example of the present invention, the front surface Ga of the tempered glass G was curved into a concave surface by the pressing force of the wheel cutter 3 so that the thickness of the front surface-side compressive stress layer was increased. As a result, such a risk was able to be prevented that the tensile stress was applied to the cracks generated from the median cracks during the forming of the scribe lines S.

### REFERENCE SIGNS LIST

1 scribing apparatus
2 support stage
3 wheel cutter
4 pressure bar
G tempered glass
Ga front surface of tempered glass
Gb back surface of tempered glass
S scribe line
C crack
V space
A1 front surface-side compressive stress layer
A2 back surface-side compressive stress layer
B intermediate tensile stress layer
N center in thickness direction
Z increasing direction of front surface-side compressive stress layer
5 laser irradiation device
L laser
6 support member
7 pressure roller
8 frame-like member
9 support plate
X preset cleaving line

1. A cleaving method for tempered glass, comprising forming a scribe line on a front surface side of the tempered glass along a preset cleaving line, followed by cleaving the tempered glass with the scribe line as a boundary,
the tempered glass comprising:
a front surface-side compressive stress layer being formed on the front surface side of the tempered glass in the thickness direction and having compressive stress applied thereto;
a back surface-side compressive stress layer being formed on a back surface side of the tempered glass in the thickness direction and having compressive stress applied thereto; and
an intermediate tensile stress layer being formed between the front surface-side compressive stress layer and the back surface-side compressive stress layer and having tensile stress applied thereto,
the forming of the scribe line comprising increasing a thickness of the front surface-side compressive stress layer at least in the vicinity of the preset cleaving line.

2. The cleaving method for tempered glass according to claim 1, wherein the increasing of the thickness of the front surface-side compressive stress layer is carried out by curving the front surface of the tempered glass into a concave surface at least in the vicinity of the preset cleaving line.

3. The cleaving method for tempered glass according to claim 1, wherein the increasing of the thickness of the front surface-side compressive stress layer is carried out by heating the front surface side of the tempered glass and/or cooling the back surface side of the tempered glass in the vicinity of the preset cleaving line.

4. The cleaving method for tempered glass according to claim 1, wherein a depth of the scribe line in the thickness direction is less than or equal to the increased thickness of the front surface-side compressive stress layer.

5. The cleaving method for tempered glass according to claim 2, wherein the thickness of the front surface-side compressive stress layer before the thickness is increased is 30% or less of a thickness of the tempered glass.

6. The cleaving method for tempered glass according to claim 1, further comprising, after the forming of the scribe line, applying tensile stress around the scribe line so as to cleave the tempered glass.

7. The cleaving method for tempered glass according to claim 1, further comprising, after the forming of the scribe line, canceling the increasing of the thickness of the front surface-side compressive stress layer, and maintaining a state in which the increasing of the thickness of the front surface-side compressive stress layer is canceled.

8. The cleaving method for tempered glass according to claim 1, wherein the forming of the scribe line is carried out by pressing a wheel cutter.

9. The cleaving method for tempered glass according to claim 1, wherein the forming of the scribe line is carried out by irradiation of laser.

10. The cleaving method for tempered glass according to claim 2, wherein a depth of the scribe line in the thickness direction is less than or equal to the increased thickness of the front surface-side compressive stress layer.

11. The cleaving method for tempered glass according to claim 3, wherein a depth of the scribe line in the thickness direction is less than or equal to the increased thickness of the front surface-side compressive stress layer.
